(19) United States
(12) Patent Application Publication
(10) Pub. No.: US 2008/0167038 A1
(43) Pub. Date: Jul. 10, 2008

(54) METHOD AND TERMINAL FOR SHORT RANGE WIRELESS COMMUNICATION

(75) Inventors: Lixin Sun, Shenzhen (CN); Yongfeng Zhong, Shenzhen (CN); Yongjun Liu, Shenzhen (CN)

Correspondence Address: DARBY & DARBY P.C., P.O. BOX 770, Church Street Station, New York, NY, 10008-0770, US

(73) Assignee: HUAWEI TECHNOLOGIES CO., LTD., Shenzhen (CN)

(21) Appl. No.: 12/052,905

(22) Filed: Mar. 21, 2008

Related U.S. Application Data
(63) Continuation-in-part of application No. PCT/CN2006/002273, filed on Sep. 4, 2006.

(30) Foreign Application Priority Data
Sep. 21, 2005 (CN) 200510104861.5

(51) Int. Cl. H04Q 7/20

(52) U.S. Cl. 455/435.1

(57) ABSTRACT

In a short distance wireless communication method, an originating communication terminal establishes a Personal Area Network based on a beacon, a receiving communication terminal connects to the Personal Area Network established by the originating communication terminal, and a short distance wireless communication between the originating communication terminal and receiving communication terminal is carried out based on a contention service channel resource in the Personal Area Network. A communication range of short distance wireless communication can be increased without increasing power consumption and while maintaining battery life of the communication terminal.

### CROSS REFERENCE TO RELATED APPLICATIONS

This application is a continuation of International Patent Application No. PCT/CN2006/002273, filed on Sep. 4, 2006, and claims the benefit of Chinese Patent Application No. 200510104861.5, filed on Sep. 21, 2005, each of which is incorporated by reference in its entirety herein. The PCT application published in Chinese as Publication No. WO2007/033575 A1.

### FIELD OF THE INVENTION

The present invention relates to the field of short range wireless communication technologies, and in particular to a method and a terminal for short range wireless communication.

### BACKGROUND OF THE INVENTION

Conventionally, a communication network system generally includes two parts, an infrastructure network and a plurality of communication terminals. In general, different communication terminals communicate with each other through the infrastructure network. For example, when a user A calls a user B, the user A shall send data to a switch at the network side, and the switch at the network side forwards the data to the user B.

With rapid development of communication technologies, different communication terminals exchange and share data more and more frequently, for example, data information, such as a business card, a short message, a picture and the like, is often exchanged between communication terminals. When two communication terminals are not far away from each other, users usually desire to transport the data information to each other directly instead of through the infrastructure network. So a plurality of short range wireless communication methods emerged, for example, a wire transmission based short range wireless communication method, such as transmission via a data line; and a wireless transmission based short range wireless communication method, such as infrared, Bluetooth and the like.

FIG. 1 illustrates schematic diagram of communication between a communication terminal 1 and a communication terminal 2 through an infrastructure network.

FIG. 2 illustrates schematic diagram of point-to-point short range communication between the communication terminal 1 and the communication terminal 2 independent of the infrastructure network.

Conventionally, the short range wireless communication methods generally include two methods, Infrared Data Association (IrDA) communication and Bluetooth. The two short range wireless communication methods and corresponding technical problem are described briefly below.

Firstly, the IrDA communication method is one of the most commonly used point-to-point wireless data communication methods. Infrared is used as physical transmission medium for data communication at a typical transmission rate which does not exceed 112 Kbps.

Secondly, the Bluetooth communication method is another method commonly adopted for short range wireless data transmission between communication terminals and utilizes a technology of 2.4 GHz frequency hopping spread spectrum at a data transmission rate which does not exceed 1 Mbps.

### SUMMARY OF THE INVENTION

The present invention includes a method for short range wireless communication. An originating communication terminal establishes a beacon-based Personal Area Network (PAN), a receiving communication terminal joins in the PAN established by the originating communication terminal, and short range wireless communication is preferred between the originating communication terminal and the receiving communication terminal based upon contention for a service channel resource in the Personal Area Network.

Further, according to the present invention, a communication terminal for short range wireless communication includes a PAN establishment unit adapted to establish a beacon based PAN, a joining permission processing unit adapted to process the joining of other communication terminal in the PAN, a channel resource contention unit adapted to contend with the other communication terminal for a service channel resource in the PAN, and a communication unit adapted to perform short range wireless communication with the other communication terminal based upon the service channel resource obtained by the channel resource contention unit through contention.

### BRIEF DESCRIPTION OF THE DRAWINGS

The invention will become more readily apparent from the Detailed Description of the Invention, which proceeds with reference to the drawings, in which:

FIG. 1 is a schematic diagram of communication between a communication terminal 1 and a communication terminal 2 through an infrastructure network;

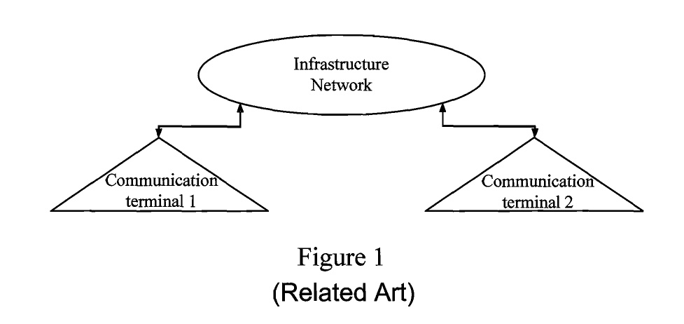

FIG. 2 is a schematic diagram of point-to-point short range communication between the communication terminal 1 and the communication terminal 2 independent of the infrastructure network;

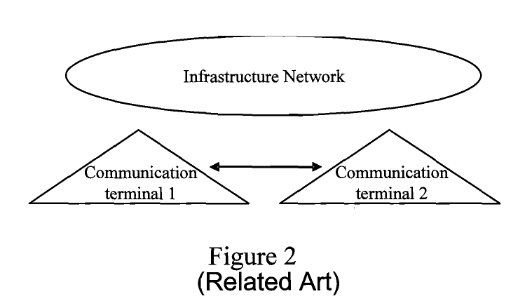

FIG. 3 is a flow chart of a principle of a method for short range wireless communication according to an embodiment of the present invention;

FIG. 4 is a schematic diagram of a frame structure of a data frame with a beacon according to an embodiment of the invention;

FIG. 5 is a schematic diagram of a method for a receiving communication terminal joining in a PAN established by an originating communication terminal according to an embodiment of the invention;

FIG. 6 is a schematic diagram of a method for short range wireless communication between the originating communication terminal and the receiving communication terminal based upon the PAN established by the originating communication terminal according to an embodiment of the invention;

FIG. 7 is a schematic diagram of method for performing short range wireless data communication between a communication terminal A and a communication terminal B according to an embodiment of the invention;

FIG. 8 is a block diagram of the communication terminal according to an embodiment of the invention;

FIG. 9 is a block diagram of a PAN establishment unit in the communication terminal according to an embodiment of the invention;

FIG. 10 is a block diagram of a joining permission processing unit in the communication terminal according to an embodiment of the invention;

FIG. 11 is a block diagram of a communication unit in the communication terminal according to an embodiment of the invention;

FIG. 12 is a block diagram of the communication terminal to which a joining request processing unit is added according to an embodiment of the invention;

FIG. 13 is a block diagram of the joining request processing unit in the communication terminal according to an embodiment of the invention; and

FIG. 14 is a block diagram of the communication unit in the communication terminal according to an embodiment of the invention.

### DETAILED DESCRIPTION OF THE INVENTION

In practice, for the short range wireless communication, the Infrared Data Association (IrDA) communication method has the following technical problems:

1. The communication range is relatively short and typically around 1.0 meter.

2. Since the IrDA communication technology adopts a non-Omnidirectional antenna, data can be transmitted only if transceivers are “aligned” (i.e., respective infrared interfaces are aligned) between communication terminals which need to transmit the data, and also the angle of the antenna is maintained within a range of 30 degrees.

3. Data transmission range is easily influenced by weather and environment. Weather such as rain, snow, fog and the like, can result in a considerable attenuation of the infrared propagation.

In practice, for the short range wireless communication, Bluetooth communication methods have the following technical problems:

The communication range is relatively short, and typically does not exceed 10 meters. Further, the transmission range of data can also be improved by increasing transmission power of a transmitter, but the power increase consumes energy of a battery in a communication terminal and shortens the lifetime of the battery.

In order to improve a communication range with less power consumption of a battery to prolong lifetime of battery in a communication terminal, the present invention provides a method for short range wireless communication, i.e., a method for sharing data between communication terminals. The short range wireless communication method of the present invention implements short range wireless communication based upon IEEE 802.15.4 standards. The method uses a direct sequence spread spectrum technology at a frequency band of 2.4 GHz. The communication terminal enters an operation status immediately by direct sequence spread spectrum technology if data is needed for short range wireless transmission, and the short range wireless communication function of the communication terminal is in a sleep status if the communication terminal has no data for short range wireless transmission.

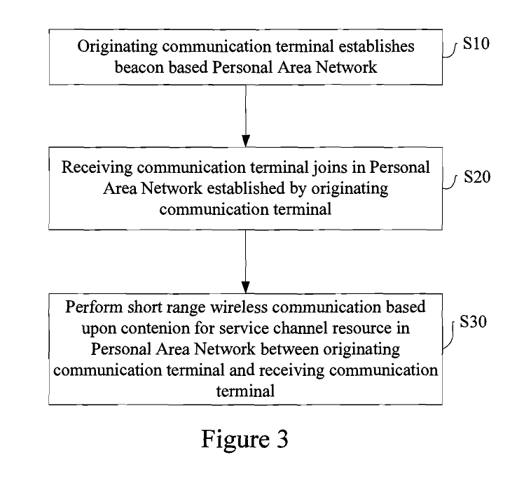

FIG. 3 provides a flow chart illustrating a method for short range wireless communication, and the method is described in further detail below.

At block 10, an originating communication terminal establishes a beacon-based Personal Area Network (PAN); particularly, the originating communication terminal triggers establishment of the beacon-based PAN if data is needed for transmission.

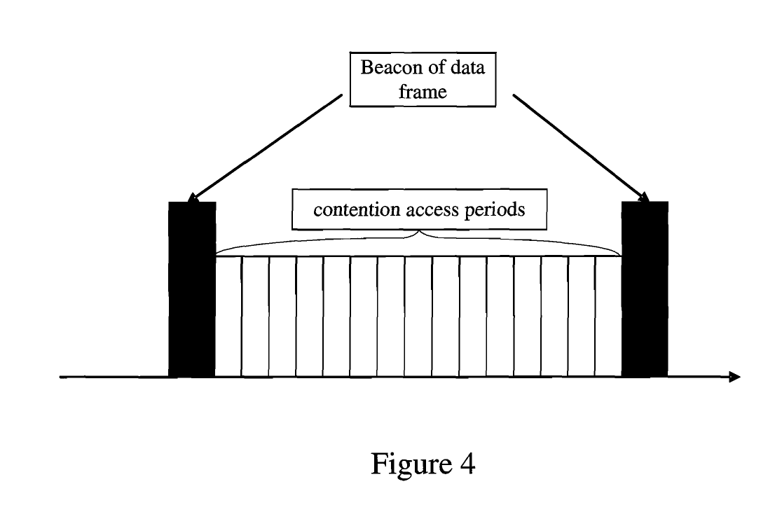

Since the short range wireless communication method of the invention is based upon IEEE 802.15.4 standards, the PAN originated and established by the originating communication terminal performs short range data transmission based upon a data frame with the beacon, and FIG. 4 provides a schematic diagram of the frame structure of the data frame with the beacon of a embodiment of the invention. One time slot is reserved as a beacon at the beginning of each data frame, and a following fifteen time slots are used for data transmission. A sender and a receiver contend for the fifteen time slots for data transmission in the data frame with the beacon to perform short range data transmission.

Particularly, a method for originating communication terminal establishing its PAN is described in detail as follows.

First, the originating communication terminal selects an ID of a PAN ready for establishing, for short, named “PAN ID”, a confliction is avoided between the PAN ID selected by the originating communication terminal and an ID of any currently established PAN, in other words, the PAN ID selected by the originating communication terminal is different from the ID of any currently established PAN;

then, the originating communication terminal carries the selected PAN ID in the beacon for broadcasting to accomplish the establishment of its PAN, where the originating communication terminal may broadcast periodically the beacon carrying the PAN ID.

At block 20, a receiving communication terminal joins in the PAN established by the originating communication terminal.

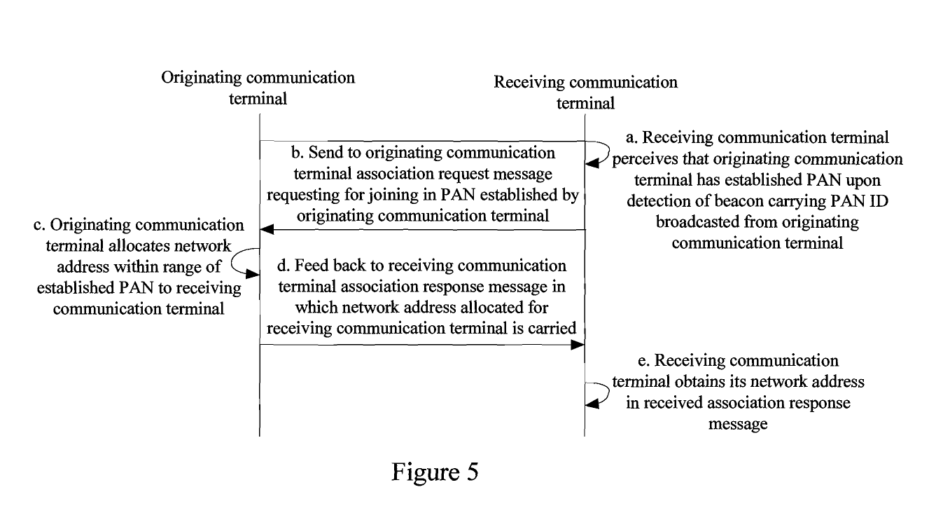

FIG. 5 illustrates a schematic diagram of a method for a receiving communication terminal joining in a PAN established by an originating communication terminal, and the method is described in details as follows.

a. The receiving communication terminal listens to a surrounding network environment continuously. The receiving communication terminal perceives that the originating communication terminal has established the PAN, when the beacon carrying the PAN ID broadcasted from the originating communication terminal is detected.

b. If the receiving communication terminal wishes to join in the PAN established by the originating communication terminal, the receiving communication terminal sends to the originating communication terminal an association request message for requesting joining in the PAN established by the originating communication terminal;

c. The originating communication terminal receives the association request message sent from the receiving communication terminal, and allocates a network address within the range of its established PAN to the receiving communication terminal.

d. The originating communication terminal send an association response message to the receiving communication terminal, and the network address allocated for the receiving communication terminal is carried in the association response message.

e. The receiving communication terminal obtains the network address in the received association response message, and joins in the PAN originated and established by the originating communication terminal.

A method for a communication terminal A establishing its PAN and a communication terminal B joining in the PAN established by the communication terminal A of the embodiments of the invention is described in details as follows.

Step 1: The communication terminal A serving as a coordinator first selects a PAN ID which has no confliction with any existing PAN ID, and carries the selected PAN ID in the beacon for periodically broadcasting.

Step 2: If the communication terminal B detects the beacon through listening and desires to join in the PAN established by the communication terminal A, the communication terminal B originates an association request to the communication terminal A with an MAC command frame, and waits for a response.

Step 3: The communication terminal A accepts the association request sent from the communication terminal B. The communication terminal A allocates the communication terminal B with a network address within the range of its established PAN. The communication terminal A responds to the communication terminal B with the association response message, which carries the allocated network address.

Step 4: The communication terminal B obtains the network address from the association response message sent from the communication terminal A, and joins in the PAN established by the communication terminal A according to the network address.

At block S30 of FIG. 3, short range wireless communication is performed between the originating communication terminal and the receiving communication terminal, based upon contention for a service channel resource in the PAN established by the originating communication terminal.

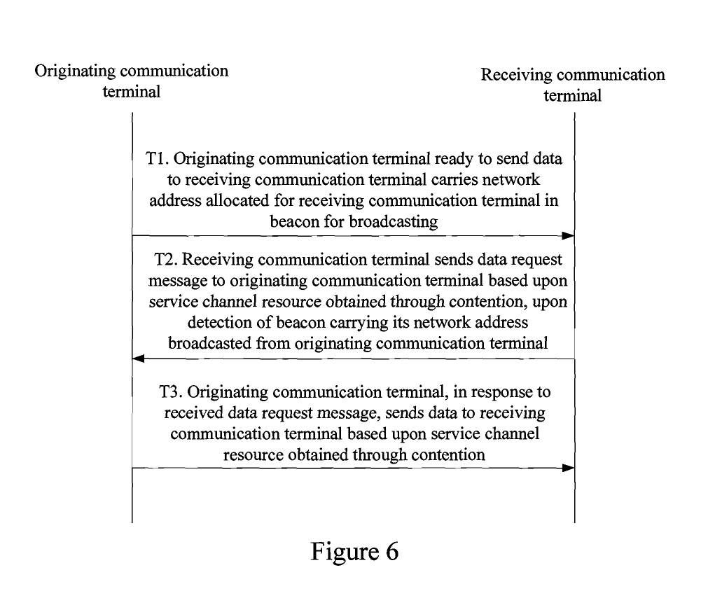

FIG. 6 provides a schematic diagram of the method for short range wireless communication between the originating communication terminal and the receiving communication terminal, based upon the PAN established by the originating communication terminal. The method is described in detail as follows.

T1. The originating communication terminal ready to send data to the receiving communication terminal carries the network address allocated for the receiving communication terminal in a beacon for broadcasting. The originating communication terminal may broadcast periodically the beacon carrying the network address of the receiving communication terminal;

T2. The receiving communication terminal sends a data request message to the originating communication terminal based upon a service channel resource, the service channel resource is obtained through contention, if the beacon carrying the allocated network address broadcasted from the originating communication terminal is detected by listening.

Optionally, the originating communication terminal sends a reception acknowledgment message to the receiving communication terminal upon reception of the data request message sent from the receiving communication terminal; and

T3. The originating communication terminal, in response to the received data request message, sends data to the receiving communication terminal based upon a service channel resource obtained through contention.

Optionally, the receiving communication terminal sends a reception acknowledgment message to the originating communication terminal upon reception of the data sent from the originating communication terminal.

Particularly, the originating communication terminal and the receiving communication terminal may contend for a service channel resource in the PAN based upon a standard approach of Carrier Sense Multiple Access with Collision Avoidance (CSMA-CA).

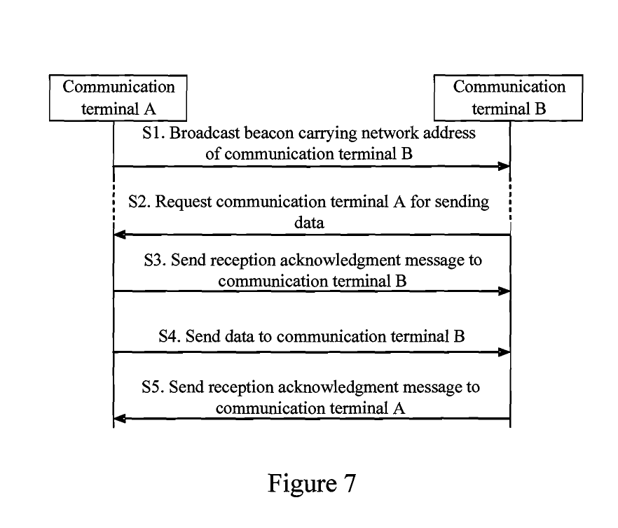

FIG. 7 illustrates a schematic diagram of the method for performing short range wireless data transmission between the communication terminal A and the communication terminal B of an embodiment, and the method is described in details as follows.

Step S1: The communication terminal A broadcasts a beacon carrying the network address of the communication terminal B;

Step S2: The communication terminal B requests the communication terminal A to send data, when the communication terminal B detects the beacon carrying the network address broadcasted from the communication terminal A by listening.

Step S3. The communication terminal A sends to the communication terminal B a reception acknowledgment message upon reception of the request message sent from the communication terminal B;

Step S4: The communication terminal A, in response to the request sent from the communication terminal B, sends data to the communication terminal B.

Step S5: The communication terminal B responds a reception acknowledgment message to the communication terminal A upon reception of the data sent from the communication terminal A.

An embodiment of the method of the invention is described below.

When two communication terminals are ready to communicate with each other, one communication terminal, named “communication terminal A”, first originates establishment of a network, i.e., a coordinator in a Wireless Personal Area Network (WPAN). The communication terminal A acts as an originator to establish a Personal Area Network with a frame structure with a beacon. Another communication terminal, named “communication terminal B” searches the network and finds the PAN established by the communication terminal A, and then joins in the PAN.

After establishment of the PAN, the communication terminal A indicates in a broadcasted beacon that the data is needed for transmission to the communication terminal B. The communication terminal B finds that there is data for reception, upon listening of the network beacon, then sends a data request command to the communication terminal A during a contention access period, i.e., parts of a data frame other than the beacon. The communication terminal A sends to the communication terminal B the data for transmission during the contention access period upon reception of the request command.

In particular, a channel resource for data transmission is obtained in the approach of Carrier Sense Multiple Access with Collision Avoidance (CSMA-CA) during a contention access period.

The communication terminal of the present invention may comprise such a terminal device as a mobile phone (a handset), a fixed phone, a PDA and the like.

According to embodiments of the present invention, the originating communication terminal first establishes a beacon-based Personal Area Network (PAN). The receiving communication terminal joins in the PAN established by the originating communication terminal; and subsequently, short range wireless communication may be performed between the originating communication terminal and the receiving communication terminal based upon contention for the service channel resources in the PAN. This short range wireless communication between the communication terminals is proposed based upon the specification of the existing IEEE 802.15.4 standards. Short range wireless communication implemented in accordance with the IEEE 802.15.4 specification improves the data transmission range relative to existing Bluetooth communication and infrared data communication. For example, a communication range of 10 meters as realized by the Bluetooth communication technology may be improved to 100 meters with an IEEE 802.15.4 communication, and need not increase excessively the transmission power of a transmitter in a communication terminal as compared with the Bluetooth communication technology. Therefore, power energy of a battery in the communication terminal is saved, and the lifetime of the battery in the communication terminal is maintained.

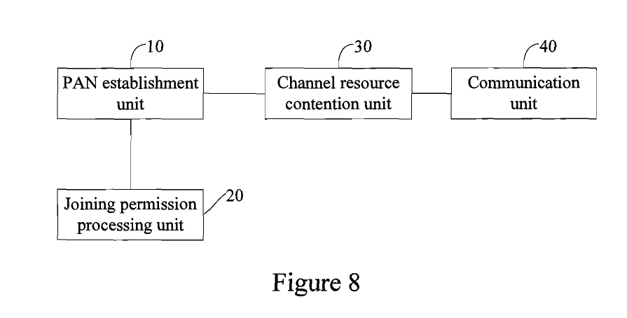

An embodiment of the invention further provides a communication terminal as illustrated in FIG. 8, which illustrates a block diagram of the communication terminal according to the embodiment of the invention. The communication terminal includes a PAN establishment unit 10, a joining permission processing unit 20, a channel resource contention unit 30 and a communication unit 40, and the functions of the respective components are described in details as follows.

The PAN establishment unit 10 is adapted to establish a beacon-based Personal Area Network;

The joining permission processing unit 20 is adapted to join another communication terminal in the PAN established by the PAN establishment unit 10;

The channel resource contention unit 30 is adapted to contend with another communication terminal for a service channel resource in the PAN established by the PAN establishment unit 10, further, the channel resource contention unit 30 contends for the service channel resource in the PAN established by the PAN establishment unit 10 based upon the approach of Carrier Sense Multiple Access with Collision Avoidance (CSMA-CA).

The communication unit 40 is adapted to perform short range wireless communication with another communication terminal based upon the service channel resource obtained by the channel resource contention unit 30 through contention.

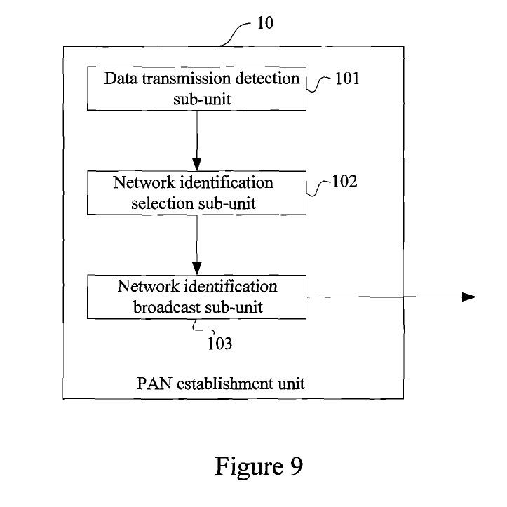

As illustrated in FIG. 9, a PAN establishment unit in the communication terminal includes a data transmission detection sub-unit 101, a network identification selection sub-unit 102 and a network identification broadcast sub-unit 103. The functions of the respective components are as follows.

The data transmission detection sub-unit 101 is adapted to detect whether the communication terminal has data for transmission;

The network identification selection sub-unit 102 is adapted to select an ID of a Personal Area Network (PAN) when the data transmission detection sub-unit 101 detects that the communication terminal has data for transmission, where a confliction of the selected PAN ID with any existing PAN ID, i.e., use of the existing PAN ID shall be avoided.

The network identification broadcast sub-unit 103 is adapted to broadcast a beacon in which the PAN ID selected by the network identification selection sub-unit 102 is carried to establish the PAN of the communication terminal.

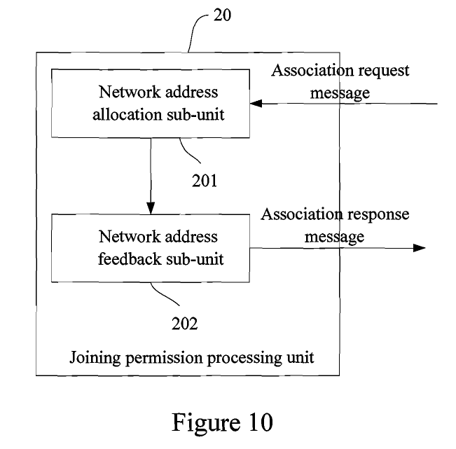

As illustrated in FIG. 10, a joining permission processing unit in the communication terminal includes a network address allocation sub-unit 201 and a network address feedback sub-unit 202, and the functions of the respective components are as follows.

The network address allocation sub-unit 201 is adapted to allocate another communication terminal with a network address within the range of the PAN established by the PAN establishment unit 10, when an association request message sent from another communication terminal is received.

The network address feedback sub-unit 202 is adapted to feed back to another communication terminal an association response message, the network address allocated for the another communication terminal by the network address allocation sub-unit 201 is carried in the association response message.

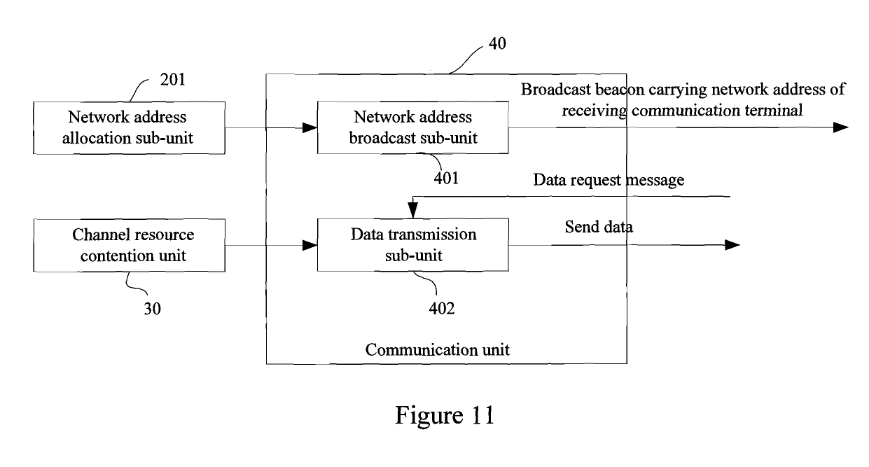

As illustrated in FIG. 11, a communication unit in the communication terminal includes a network address broadcast sub-unit 401 and a data transmission unit 402, and the functions of the respective components are as follows.

The network address broadcast sub-unit 401 is adapted to broadcast a beacon, the network address allocated for a receiving communication terminal by the network address allocation sub-unit 201 is carried in the beacon, when a communication terminal is ready to send data to another communication terminal.

The data transmission sub-unit 402 is adapted to send data to the receiving communication terminal based upon the service channel resource obtained by the channel resource contention unit 30 through contention, upon reception of a data request message sent from the receiving communication terminal.

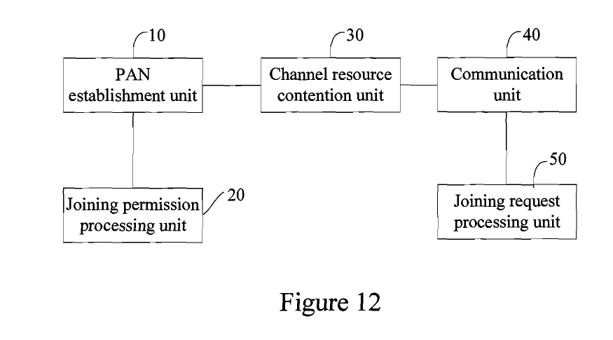

As illustrated in FIG. 12, in a communication terminal according to an embodiment of the invention, and based upon the above structure of the primary components in FIG. 8, a join request processing unit 50 is further included to join in a Personal Area Network (PAN) established by another communication terminal.

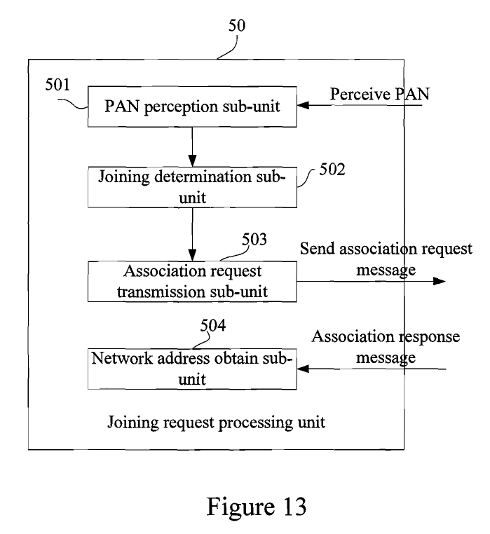

As illustrated in FIG. 13, the joining request processing unit 50 includes a PAN perception sub-unit 501, a joining determination sub-unit 502, an association request transmission sub-unit 503 and a network address obtain sub-unit 504, and the functions of the respective components are as follows.

The PAN perception sub-unit 501 is adapted to perceive that another communication terminal is established a PAN upon detection of a beacon carrying a PAN ID broadcasted from another communication terminal.

The joining determination sub-unit 502 is adapted to judge whether the user is desired to join in the PAN perceived by the PAN perception sub-unit 501.

The association request transmission sub-unit 503 is adapted to send to the another communication terminal an association request message requesting for joining in the PAN established by the another communication terminal when a determination result of the joining determination sub-unit 502 is positive.

The network address obtain sub-unit 504 is adapted to obtain network address information in an association response message fed back from another communication terminal.

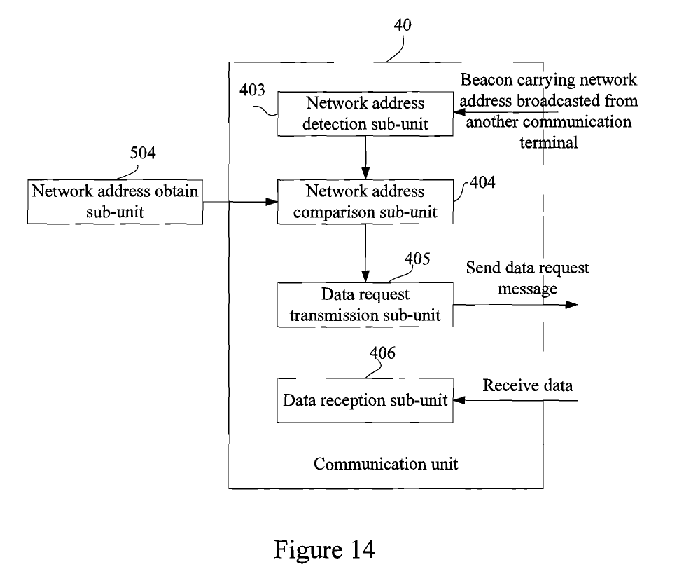

As illustrated in FIG. 14, components further included in communication unit 40 in the communication terminal, and in addition to the above respective components include a network address detection sub-unit 403, a network address comparison sub-unit 404, a data request transmission unit 405 and a data reception sub-unit 406. The functions of the respective components are as follows.

The network address detection sub-unit 403 is adapted to detect the network address information carried in the beacon broadcasted from another communication terminal.

The network address comparison sub-unit 404 is adapted to compare the network address information detected by the network address detection sub-unit 403 with the network address obtained by the network address obtain sub-unit 504 to judge whether they are identical.

The data request transmission unit 405 is adapted to send a data request message to the another communication terminal based upon the service channel resource obtained by the channel resource contention unit 30 through contention, when a comparison result of the network address comparison sub-unit 404 is positive.

The data reception sub-unit 406 is adapted to receive data sent from another communication terminal.

The communication terminal of the embodiments of the invention may be a terminal device such as a mobile phone (a handset), a fixed phone, a PDA and the like. In a physical sense, the communication terminal according to the present invention may be a conventional communication terminal based upon which a short message wireless communication module in compliance with the IEEE 802.15.4 specification is added. Specifically, the communication terminal of the embodiments of the invention includes a primary function part and a wireless communication module in compliance with the IEEE 802.15.4 specification, where the primary function part is adapted to accomplish communication functions of the conventional communication terminal per se, such as functions of a phone, short messages and the like. The wireless communication module in compliance with the IEEE 802.15.4 specification is adapted to accomplish data communication between communication terminals in a short range. The relationship between the primary function part and the wireless communication module in compliance with the IEEE 802.15.4 specification may be close coupling, in other words, the primary function part and the wireless communication module are integrated together, or loose coupling, in other words, the primary function part and the wireless communication module are separated physically and combined in an electric connection.

It is evident that those skilled in the art may make modifications and variations to the invention without departing from the spirit and scope of the invention. Accordingly, the invention is intended to encompass these modifications and variations provided that they fall within the scope of the appended claims of the invention and all foreseeable equivalents thereof.

What is claimed is:

1. A method for short range wireless communication, comprising the steps of:
establishing, by an originating communication terminal, a beacon-based Personal Area Network(PAN);
joining, by a receiving communication terminal, in the PAN established by the originating communication terminal; and
performing short range wireless communication between the originating communication terminal and the receiving communication terminal based upon contention of a service channel resource in the PAN.

2. The method according to claim 1, wherein the originating communication terminal establishes the beacon-based PAN when having data for transmission.

3. The method according to claim 1, wherein the step of establishing by the originating communication terminal of the beacon based PAN further comprises the steps of:
selecting, by the originating communication terminal, an identification of the PAN ready to be established; and
broadcasting the beacon, wherein the selected identification of PAN is carried in the beacon.

4. The method according to claim 3, wherein the beacon is broadcasted periodically.

5. The method according to claim 1, wherein the step of joining by the receiving communication terminal in the PAN established by the originating communication terminal comprises:
perceiving, by the receiving communication terminal, that the PAN is established by the originating communication terminal, upon detection of the beacon;
sending to the originating communication terminal an association request message for requesting joining in the PAN;
allocating, by the originating communication terminal, the receiving communication terminal with a network address within the range of the established PAN, upon reception of the association request message;
feeding back to the receiving communication terminal an association response message, the network address is carried in the association response message; and
obtaining, by the receiving communication terminal, the network address from the association response message.

6. The method according to claim 1, wherein the step of performing short range wireless communication comprises:
broadcasting the beacon by the originating communication terminal ready to send data to the receiving communication terminal, the beacon carries a network address allocated for the receiving communication terminal;
sending, by the receiving communication terminal, a data request message to the originating communication terminal based upon the service channel resource, if the network address carried in the beacon is detected; and
sending, by the originating communication terminal, data to the receiving communication terminal based upon the service channel resource.

7. The method according to claim 6, wherein the originating communication terminal periodically broadcasts the beacon carrying the network address of the receiving communication terminal.

8. The method according to claim 6 further comprising the step of sending, by the originating communication terminal, a reception acknowledgment message to the receiving communication terminal based upon the service channel resource, upon reception of the data request message.

9. The method according to claim 6 further comprising the step of sending, by the receiving communication terminal, a reception acknowledgment message to the originating communication terminal based upon the service channel resource obtained, upon reception of the data sent from the originating communication terminal.

10. The method according to claim 1, wherein the originating communication terminal and the receiving communication terminal contend for the service channel resource based upon an approach of Carrier Sense Multiple Access with Collision Avoidance.

11. A communication terminal, comprising:
a PAN establishment unit adapted to establish a beacon-based PAN;
a joining permission processing unit adapted to process the joining of another communication terminal in the PAN;
a channel resource contention unit adapted to contend with the other communication terminal for a service channel resource in the PAN; and
a communication unit adapted to perform short range wireless communication with the other communication terminal based upon the service channel resource obtained by the channel resource contention unit through contention.

12. The communication terminal according to claim 11, wherein the PAN establishment unit further comprises:
a data transmission detection sub-unit adapted to detect whether the communication terminal has data for transmission;
a network identification selection sub-unit adapted to select an identification of the PAN when the data transmission detection sub-unit detects that the communication terminal has data for transmission; and
a network identification broadcast sub-unit adapted to broadcast the beacon in which the identification of the PAN is carried.

13. The communication terminal according to claim 11, wherein the joining permission processing unit further comprises:
a network address allocation sub-unit adapted to allocate the another communication terminal with a network address within the range of the PAN established by the PAN establishment unit, upon reception of an association request message sent from the another communication terminal; and
a network address feedback sub-unit adapted to feed back to the another communication terminal an association response message, the network address allocated for the another communication terminal by the network address allocation sub-unit is carried in the association response message.

14. The communication terminal according to claim 11, wherein the channel resource contention unit contends for the service channel resource based upon an approach of Carrier Sense Multiple Access with Collision Avoidance.

15. The communication terminal according to claim 11, wherein the communication unit further comprises:
a network address broadcast sub-unit adapted to broadcast the beacon in which a network address allocated for the another communication terminal is carried, when the communication terminal is ready to send data to the other communication terminal; and
a data transmission unit adapted to send data to the other communication terminal based upon the service channel resource, upon reception of a data request message sent from the another communication terminal.

16. The communication terminal according to claim 11, further comprising a joining request processing unit adapted to join in the PAN established by the other communication terminal.

17. The communication terminal according to claim 16, wherein the joining request processing unit further comprises:
a PAN perception sub-unit adapted to perceive that the other communication terminal has established the PAN, upon detection of the beacon carrying an identification of the PAN broadcasted from the another communication terminal;
a joining determination sub-unit adapted to judge whether a user wishes to join in the PAN perceived by the PAN perception sub-unit;
an association request transmission sub-unit adapted to send to the other communication terminal an association request message for requesting joining in the PAN established by the other communication terminal, when a determination result of the joining determination sub-unit is positive; and
a network address obtain sub-unit adapted to obtain a network address in an association response message fed back from the another communication terminal.

18. The communication terminal according to claim 17, wherein the communication unit further comprises:
a network address detection sub-unit adapted to detect network address information carried in the beacon broadcasted from the another communication terminal;
a network address comparison sub-unit adapted to compare the network address information detected by the network address detection sub-unit with the network address obtained by the network address obtain sub-unit to judge whether they are identical;
a data request transmission unit adapted to send a data request message to the other communication terminal based upon the service channel resource, when the comparison result of the network address comparison sub-unit is positive; and
a data reception sub-unit adapted to receive data sent from the other communication terminal.
